(19) United States
(12) Patent Application Publication
(10) Pub. No.: US 2019/0084034 A1
(43) Pub. Date: Mar. 21, 2019

(54) PROCESS OF LOST WAX MICRO CASTING WITH RECYCLING OF EXHAUSTED WAX

(71) Applicant: EUROPEA MICROFUSIONI AEROSPAZIALI S.P.A., Morra De Sanctis (IT)

(72) Inventors: Mario IORLANO, Morra De Sanctis (IT); Angelo LOTRECCHIANO, Morra De Sanctis (IT)

(21) Appl. No.: 16/065,618

(22) PCT Filed: Dec. 27, 2016
(86) PCT No.: PCT/IT2016/000306

§ 371 Date: Jun. 22, 2018

(30) Foreign Application Priority Data
Dec. 24, 2015 (IT) 102015000087609

(51) Int. Cl. B22C 7/02; C10G 73/40; C08L 91/06

(52) U.S. Cl. CPC B22C 7/02; C10G 73/40; C10G 2300/1003; C08L 2205/025; C08L 91/06

(57) ABSTRACT

Recycling of exhausted wax in a process of lost wax micro casting.

The present invention relates to a process of lost wax microcasting with recycling of exhausted wax.

It is known that the process of lost wax microcasting is commonly employed, for example, for the production of aeronautical or industrial components made of metallic material, which may be generally of the equiaxial type, or of the directional solidification (DS) tyoe, or of the “single crystal” (SX) solidification type.

According to the process of lost wax microcasting, the realisation of the components takes place by preliminarily preparing a mold in which molten wax is injected, which, by solidifying by cooling, allows to obtain a model which is identical to the final component to be produced.

The wax model is obtained by injection, using piston actuated presses. These machines inject molten wax within a mold according to well-defined parameters that depend on the geometry of the piece, and therefore on the complexity of the mold to be filled.

Typically, many models are combined together to form a so-called cluster.

The clusters are then covered with a shell constituted by a plurality of layers of refractory material, to give the shell the necessary strength.

Each refractory layer is formed by means of three main steps:

1) immersion of the wax cluster in a refractory, in particular ceramic, slurry;

2) drainage of the cluster; and

3) perfusion of the cluster with refractory sand or plaster.

The shell is then dewaxed, i.e. it is provided for the removal of the wax around which the shell itself is formed, and subsequently is treated in high-temperature ovens. The shell thus obtained is then able to accept the pouring of molten metal.

In particular, the component obtained by “single crystal” (SX) solidification is manufactured by placing the shell made of refractory material in a vacuum oven and exactly on a platform cooled by water to start the process of solidification. The molten metal is poured into the shell, and the “solidification rate” and the “direction” are controlled by the speed of extraction of the casting chamber, and by a helical selector that, when the shell is extracted from the oven, selects a single crystal , from which the component will be created.

After cooling of the metal, the ceramic shell is removed by shattering it, and then the finish of the individual components is performed.

Waxes used for the realization of the cluster are of the “virgin” type, i.e. they are mixtures of complex chemical-physical formulation, tailored to the specific process requirements of each manufacturer, which are then processed into pellets by the manufacturer to facilitate the load in the machine and which, after first use, are no longer recovered.

In particular, waxes usually used in production can be of two types:

a first type, the most valuable, is used for the manufacturing of the models of the components to be made and a second type, less valuable, is used for the realization of connections between the models of the components, in order to constitute the cluster and accessories. In fact, while for the final components to be made the dimensional and surface finish requirements are very strict, wider margins are allowed for the cluster and accessories, although it is needed anyway to comply with well-defined parameters related to physical and mechanical properties of the material, in order to avoid other processing problems.

The two types of wax have different characteristics especially with regard to the melting temperature (melt point) and the filler content (filler). In addition, in order to facilitate their recognition during processing, the two types of wax are made with different colors.

The exhausted wax resulting from the lost wax casting manufacturing process is no more than a mixture of the two types of wax, which flows downstream of the dewaxing of the clusters (“dewaxing”), which occurs with a treatment in boilers clave, the mix of wax removed from the shell is forced to flow from the machine into a collecting container, inside which it solidifies becoming a sort of monobloc of mixed exhausted wax.

The exhausted wax must therefore be disposed of, with the related costs.

In this context it is included the solution according to the present invention, according to which it is proposed to provide for a process of lost wax micro casting wherein it is possible to reuse the exhausted wax in order to reduce disposal costs, without compromising the quality of the production of the final components.

These and other results are achieved according to the present invention by proposing a process of lost wax micro casting with recycling of exhausted wax and its use in place of the less valuable wax type, or in place of the wax used for the realization of the clusters and accessories.

The purpose of this invention is therefore a process of lost wax micro casting with recycling of exhausted wax, so as to overcome the limits imposed by the prior art and to obtain the technical results previously described.

A further object of the invention is that said process of lost wax micro casting with recycling of exhausted wax can be achieved with low costs.

Another object of the invention is to propose a process of lost wax micro casting with recycling of exhausted wax which is simple, safe and reliable.

It is therefore a first specific object of the present invention a process of lost wax micro casting with recycling of exhausted wax, comprising the following steps:
molding of one or more wax models, identical to the end pieces to produce, using a first formulation of wax;
molding of one or more molds of sprues (connecting passages), using a second formulation of wax;
assembling of said one or more models and said one or more molds of sprues, to form a cluster;
coating of said cluster with a ceramic shell;
removing of wax from said shell;
treating of said shell in an oven;
casting of molten metal alloy within said shell and subsequent cooling to obtain a solidified casting;
cracking of the shell to release the solidified casting;
removing of the sprues and finishing of the pieces;
   and characterised in that it additionally comprises the following steps:
melting of the exhausted wax coming from said step of removing wax from said shell, to obtain a molten exhausted wax;
removing of water from said molten exhausted wax, to obtain de-hydrated molten exhausted wax;
removing of ceramic residues, ashes or other impurity by filtration of said de-hydrated molten exhausted wax, to obtain recycled wax;
adding virgin wax (grade 50-60° C.) in a quantity equal to at least 30% by weight of the total of the recycled wax, and at least equal to the amount of recycled wax in the case in which the same has been already obtained following a process of lost wax micro casting in which a wax formulation that contain recycled wax was used, to obtain said second formulation of wax;
delivering of said second formulation of wax to said molding of one or more molds of sprues.

Preferably, according to the invention, said step of removing ceramic residues, ashes or other impurity by filtration is such as to reduce the ash content down to a level not higher than 0.05% by weight of the total of said second formulation of wax.

Optionally, according to the invention, after or simultaneously with said step of adding virgin wax, a dye is also added, preferably in an amount lower than 0.01% by weight of the total of said second formulation of wax.

More preferably, always according to the present invention said second formulation of is characterised by having the following properties:
freezing point: 58-64° C.
melting point (drop melt point): 65-71° C.
ash content: 0.05% by weight
penetration: 8-14 dmm
viscosity at 70° C.: 0.6-1.3 Pa·s
   where the penetration is measured according to ASTM D1321 (needle penetration of petroleum waxes), using a weight equal to 250 g and the viscosity is measured using a Haake RV1 absolute viscometer with a ISO 3219 Z34 DIN cylindrical rotor with a diameter of 34 mm, using a cutting speed of 54.5 s⁻¹ and a cooling rate of 1 degree per minute in a temperature range that starts from 85° C. to 60° C.

The effectiveness of the process of lost wax micro casting with recycling of exhausted wax according to the present invention is well evident, since it allows a considerable saving, not only in terms of disposal of the exhausted wax, but also in terms of the cost of raw material, such saving depending by the planned production and being, anyway, quantifiable in a 50% reduction compared to the cost incurred for the virgin wax.

The invention will be described below for illustrative but not limitative purposes, and with particular reference to some illustrative examples.

### EXAMPLE 1

### Physical and Chemical Characteristics of the Virgin Waxes

In the installation considered by way of non limiting example to test the feasibility of the present invention the following waxes are usually used: as the less valuable type of wax, a wax with low melting point, red in color, produced by Paramelt BV and distributed by International Precision Casting Supplies Ltd, identified by the supplier code 2690FDR; and as the most valuable type of wax, a wax of green color in the form of pellets, manufactured and distributed by Blayson Olefins, with the supplier code FR60RR.

The less valuable wax has the following chemical-physical characteristics: freezing point equal to 58° C., melting point equal to 66.2° C., viscosity at 70° C. equal to 0.289 Pa·s, filler percentage content by weight equal to 0.

The most valuable wax has the following chemical-physical characteristics: freezing point equal to 66° C., melting point equal to 72° C., viscosity at 70° C. equal to 1 Pa·s, filler percentage content by weight equal to 31.1.

In both cases, viscosity is measured using a RV1 Haake absolute viscometer with a ISO 3219 Z34 DIN cylindrical rotor with a diameter of 34 mm, using a cutting speed equal to 54.5 s⁻¹ and a cooling rate of 1 degree per minute in a temperature range between 85° C. and 60° C.

The exhausted wax resulting from the manufacturing process in the system considered by way of not limiting example to test the feasibility of the present invention contains about 60% by weight of less valuable wax (red wax) and the remainder, about 40% by weight of most valuable wax (green wax).

### EXAMPLE 2

### Correction of the Characteristics of the Exhausted Wax

The exhausted wax produced by the considered installation by way of non limiting example to test the feasibility of the present invention was melt. treated to remove water and filtered through a series of filter packs, for retaining any ceramic residues derived from components used in the manufacturing (in particular for the making of the cores used in the manufacturing of blades to form hollow areas) and in any case for removing any impurity that can be arrived in the wax during the manufacturing. The filtering systems are used to maintain the final content of ash in recycled wax to a level not higher than 0.05% by weight.

Specific additives are then added that have the function of increasing the strength, viscosity and melting characteristics of the wax, or a quantity of virgin wax (grade 50-60° C.) equal to about 30% by weight of the total recycled wax is added, to make its characteristics similar to those of the virgin red wax. The wax is then transformed into pellets ready to be reused in production.

Lastly, from the technical production point of view, it is only necessary to correct some characteristics of the final product, such as color, odor and the workability of the material, to have a low impact on normal operational practice.

In fact, the color has an impact on the inspection of the components, the bad smell of the material creates problems with security, and having a stiffer wax implies greater difficulty in processing.

These three aspects can be corrected to find the right balance.

The color of the waxes can be changed by selecting from a plurality of dyes, based on the needs of the end user. In particular, to obtain the right color it is sufficient a small amount of dye, less than 0.01% by weight of the total of the recycled wax.

The smell can be pleasant or unpleasant depending on the mix of waxes and depending on the treatments they underwent, but in some ways this can be corrected by adjusting the mixture of waxes used and the treatments carried out.

### EXAMPLE 3

### Characteristics of the Recycled Wax

The properties of the recycled wax are the following:

freezing point: 58-64° C.

melting point (drop melt point): 65-71° C.

ash content: 0.05% by weight

penetration: 8-14 dmm

viscosity at 70° C.: 0.6-1.3 Pa·s

The penetration is measured according to ASTM D1321 (needle penetration of petroleum waxes), using a weight of 250 g.

The viscosity is measured by means of a Haake RV1 absolute viscometer with a ISO 3219 Z34 DIN cylindrical rotor with a diameter of 34 mm, using a cutting speed equal to 54.5 s⁻¹ and a cooling rate of 1 degree per minute in a temperature range between 85° C. and 60° C.

### EXAMPLE 4

### Further Recycling of Recycled Wax

Recycled wax can in turn be recovered after being reused in production.

To this end it is necessary to analyse the characteristics of the exhausted wax in the course of time, as it varies following repeated uses, so that during the recovery of the material it is necessary to take account of the initial and of the final characteristics of the product to be obtained, so that the main characteristics always remain within the ranges shown in Example 3.

For the purposes of compliance with the required operating parameters, this further recirculation requires the adding to the recycled wax that was treated as specified above, of an amount of virgin wax at least equal by weight.

The present invention has been described for illustrative but not limitative purposes according to its preferred embodiments, but it is to be understood that variations and/or modifications can be made by those skilled in the art without departing from the related scope of protection, as defined by the appended claims.

1. Process of lost wax micro casting with recycling of exhausted wax, comprising the steps of:
molding of one or more wax models, identical to the end pieces to produce, using a first formulation of wax;
molding of one or more molds of sprues (connecting passages), using a second formulation of wax;
assembling of said one or more models and said one or more molds of sprues, to form a cluster;
coating of said cluster with a ceramic shell;
removing of wax from said shell;
treating of said shell in an oven;
casting of molten metal alloy within said shell and subsequent cooling to obtain a solidified casting;
cracking of the shell to release the solidified casting;
removing of the sprues and finishing of the pieces;
and characterised in that it additionally comprises the following steps:
melting of the exhausted wax coming from said step of removing wax from said shell, to obtain a molten exhausted wax;
removing of water from said molten exhausted wax, to obtain de-hydrated molten exhausted wax;
removing of ceramic residues, ashes or other impurity by filtration of said de-hydrated molten exhausted wax, to obtain recycled wax;
adding virgin wax (grade 50-60° C.) in a quantity equal to at least 30% by weight of the total of the recycled wax, and at least equal to the amount of recycled wax in the case in which the same has been already obtained following a process of lost wax micro casting in which a wax formulation that contain recycled wax was used, to obtain said second formulation of wax;
delivering of said second formulation of wax to said molding of one or more molds of sprues;
wherein said second formulation of wax has the following properties:
freezing point: 58-64° C.
metting point (drop melt point): 65-71° C.
ash content: ≤0.05% by weight
penetration: 8-14 dmm
viscosity at 70° C.: 0.6-1.3 Pa·s
where the penetration is measured accordin to ASTM D1321 needle enetration of petroleum waxes), using a weight equal to 250 g and the viscosity is measured using a Haake RV1 absolute viscometer with a ISO 3219 Z34 DIN cylindrical rotor with, a diameter of 34 mm, using a cutting speed of 54.5 s-1 and a cooling rate of 1 degree per minute in a temperature range that starts from 85° C. to 60° C.

2. Process of lost wax micro casting with recycling of exhausted wax according to claim 1, wherein said step of removing ceramic residues, ashes or other impurity by filtration is such as to reduce the ash content down to a level not higher than 0.05% by weight of the total of said second formulation of wax.

3. Process of lost wax micro casting with recycling of exhausted wax according to claim 1, wherein, after or simultaneouly with said step of adding virgin wax, a dye is also added.

4. Process of lost wax micro casting with recycling of exhausted wax according to claim 3, wherein said dye is added in an amount lower than 0.01% by weight of the total of said second formulation of wax.

5. (canceled)
